(19) United States
(12) Patent Application Publication
(10) Pub. No.: US 2025/0150013 A1
(43) Pub. Date: May 8, 2025

(54) CONTROL ARRANGEMENT OF A SIX-PHASE ELECTRIC MACHINE

(71) Applicant: ZF Friedrichshafen AG, Friedrichshafen (DE)

(72) Inventors: Fabian Hohmann, Hofbieber (DE); Stefan Hain, Speichersdorf (DE); Matthias Beringer, Schweinfurt (DE)

(73) Assignee: ZF Friedrichshafen AG, Friedrichshafen (DE)

(21) Appl. No.: 18/837,427

(22) PCT Filed: Feb. 10, 2023
(86) PCT No.: PCT/EP2023/053280

§ 371 Date: Aug. 9, 2024

(30) Foreign Application Priority Data
Feb. 11, 2022 (DE) 10 2022 201 437.5

(51) Int. Cl. H02P 27/06; H02P 25/22

(52) U.S. Cl. CPC H02P 27/06; H02P 25/22

(57) ABSTRACT

A control assembly for a six-phase electric machine divided into two three-phase windings includes two three-phase inverters, each of which controls one of the three-phase windings. Each inverter has a circuit assembly with power semiconductors of different types, and/or different materials, and or different surface areas, and windings of the same phase in the inverter are wound onto the same cog and galvanically insulated from one another.

The present invention relates to the field of electric mobility, in particular the electronic modules for an electric drive.

The use of electronic modules such as power electronic modules in motor vehicles has increased significantly in the last decades. This is partially due to the need for fuel consumption and to improve vehicle performance, and partially due to the advances in semiconductor technology. The main component in such an electronic module is a DC/AC inverter with which electric machines such as electric motors or generators are supplied with a multi-phase alternating current (AC). A direct current from a DC power source such as a battery is converted to a multi-phase alternating current for this. The inverters contain numerous electronic components for this that form bridge circuits (half-bridges), e.g. semiconductor switches, which can also be referred to as power semiconductors.

Current inverters are usually made of unipolar or bipolar semiconductors. Inverters that have a combination of unipolar and bipolar semiconductors have also been proposed. A high level of efficiency can be obtained through the appropriate use of the semiconductors in inverters and the appropriate control thereof. However, an undesired incorrect distribution of the current may be the result of an electric coupling of the semiconductor.

It is therefore the object of the invention to create an improved assembly composed of an electric machine and inverters that overcome these disadvantages.

This problem is solved by the features of the independent claims. Advantageous embodiments are the subject matter of the dependent claims.

A control assembly for a six-phase electric machine subdivided into two three-phase windings, which has two three-phase inverters, each of which controls one of the three-phase windings. This assembly is distinguished in that each of the inverters contains a circuit assembly with different types of power semiconductors, and/or different materials, and/or different surface areas, with the windings of the same phase in the inverters wound onto the same cog and galvanically insulated from one another.

By controlling the different power semiconductors separately and placing the windings belonging to two different inverters on the same cog, but separating them galvanically, interferences between the semiconductors can be suppressed. This reduces the complexity of the control assembly.

In one embodiment, the inverters are identical or different with regard to their performance and/or efficiency. They can consequently be optimized to the power semiconductors they control.

In one embodiment, the windings and their dedicated inverters are optimized to one another with respect to a predefined performance and/or efficiency of the inverters, and/or a predefined operating point for the electric machine.

Optimization of the windings is obtained through adjusting the wire geometry, winding number, type of winding, orientation, and/or arrangement on the cog. The arrangement on the cog is advantageously such that the windings are placed successively, one behind the other, or concentrically, one on top of the other. As a result of the galvanic separation, the windings can be placed optimally on the cog for the respective application, such that they do not interfere with one another.

In one embodiment, one of the inverters contains power semiconductors forming a unipolar semiconductor component, and the other inverter contains power semiconductors forming a bipolar semiconductor component. One of the inverters advantageously contains power semiconductors made of a material with wider bandgaps, comprising SiC or GaN, and the other contains power semiconductors made of silicon. The power semiconductors forming unipolar semiconductor components can be MOSFETs, JFETs, or cascodes, and/or the power semiconductors forming bipolar semiconductor components can be IGBTs.

Furthermore, use of the control assembly for controlling a six-phase electric machine in a vehicle with an electric drive is proposed, which has the proposed control assembly.

An electric drive for a vehicle with a six-phase electric machine and the control assembly is also proposed.

A vehicle with an electric drive is also proposed.

Other features and advantages of the invention can be derived from the following description of exemplary embodiments of the invention based on the drawings illustrating details of the invention, and from the claims. The individual features can be implemented in and of themselves or in numerous arbitrary combinations in different versions of the invention.

Preferred embodiments of the invention shall be explained in greater detail below in reference to the drawings.

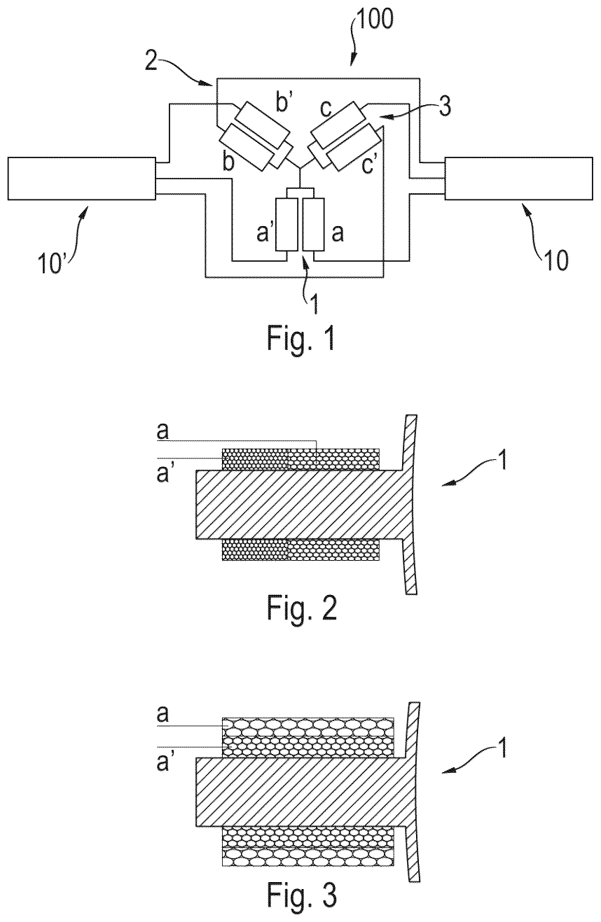

FIG. 1 shows the fundamental structure of the control assembly according to an embodiment of the present invention; and

FIGS. 2 and 3 show embodiments of windings according to different embodiments of the present invention.

Identical features have the same reference symbols.

There are six-phase inverters and six-phase electric machines in the prior art. Each winding can be contained in the inverter. In a symmetrical structure, the windings are distributed in increments of 60°. Other structures are also possible, e.g. two three-phase systems at 120° increments, with a rotation of both systems of 30°. Whether the machine has a star-shaped or triangular design is insignificant, because the explanations herein apply analogously to each. A six-phase inverter can also be divided into two three-phase inverters, to obtain redundancy in the case of a malfunction. It is also possible to connect the two neutral points, or obtain a single neutral point therewith. The inverters can have the same phases, offset at 60°, or be controlled in a different manner. If one inverter malfunctions, the motor can still be operated.

If inverters, also referred to as converters or rectifiers, are used that contain a combination of unipolar and bipolar semiconductors, a higher efficiency is obtained than previously by designing the semiconductors and semiconductor surfaces appropriately. If the semiconductors are coupled to electricity, however, a complex design is needed to prevent the semiconductors for interfering with one another. The connection to electricity depends on the combined windings. This results in an undesired incorrect distribution of the current.

The invention therefore proposes providing the six-phase machine 100 with a motor that has two three-phase windings a-c and a′-c′. Each of the three-phase windings a-c and a′-c′ is dedicated to a separate three-phase inverter 10, 10′. Each of the three-phase inverters 10, 10′ has a circuit assembly with different power conductors than the other. The power semiconductors can be of different types, and/or materials, and/or have different surface areas. As a result of the different power semiconductors in the circuit assemblies for the inverters 10, 10′, the inverters 10, 10′ can also have different designs, e.g. with regard to efficiency, performance, operating points, etc.

This means that two different inverters 10, 10′ are proposed, each of which controls a three-phase winding a-c and a′-c′ of the six-phase machine 100 separately. The windings a and a′, b and b′, and c and c′ are each wound onto the same cog 1, 2, 3, each of which belongs to a single phase, and galvanically insulated. This results in redundancy, as with existing electric machines controlled with two inverters. In the prior art, however, the inverters are always the same, i.e. they do not have power semiconductors of different types, and/or different materials, and/or different surface areas.

There can be one or more neutral points in the proposed control assembly, which can be galvanically insulated or connected.

For optimal efficiency, the inverters 10, 10′ and electric motor, or six-phase machine 100, must be optimized to one another. If two inverters 10, 10′ are used, as proposed herein, there are optimization problems for the electric motor, even if each inverter 10, 10′ has its own windings a-c and a′-c′. This means that the windings a-c and a′-c′ must be optimized for the respective inverters 10, 10′.

The optimization of the windings a-c and a′-c′ to the respective inverters 10, 10′ is advantageously based on a predefined performance, and/or efficiency, and/or operating point for the electric machine 100 that is to be obtained with the respective inverters 10, 10′.

The windings a-c and a′-c′ are optimized by adjusting the wire geometry, winding number, type of winding, orientation, and/or placement on the cogs 1, 2, 3.

FIGS. 2 and 3 show schematic, magnified illustrations of a cog 1, 2, 3 with windings a and a′ in different arrangements. In FIG. 2, the windings a and a′ are behind one another, resulting in radial windings a and a′, in which the windings a and a′ are wound successively onto the cog 1, 2, 3. The windings a and a′ are placed concentrically, one on top of the another, in FIG. 3.

The properties of each of the windings a-c and a′-c′, in particular the thickness of the copper, winding number, type of winding, orientation to one another, etc. can fundamentally be selected such that the desired optimization goal is obtained. This allows for independent optimization of the windings a-c and a′-c′ for different output performances, e.g. high efficiency and high performance. The two different windings a-c and a′-c′ on each cog 1, 2, 3 can also be optimized for different operating points, e.g. high efficiency and high performance, through the selection of the wire geometry, number of windings, and arrangement on the cogs 1, 2, 3.

For minimal use of copper, the windings a-c and a′-c′ for maximum performance can be thicker than the windings a-c and a′-c′ for maximum efficiency. To reduce copper losses in the partial-load, the windings a-c and a′-c′ for a high efficiency inverter 10 or 10′, advantageously formed by bipolar semiconductor components, can be thicker. The magnetic coupling in the cogs 1, 2, 3 can be affected by different orientations.

The above considerations for concentric coils apply analogously to machines with divided windings and windings of the same width.

The inverters 10, 10′ are therefore optimally adjusted to the respective windings a-c and a′-c′. They are made of different power semiconductors, and can have different output performances. They can have unipolar, e.g. MOSFETs, and bipolar, e.g. IGBTs, semiconductors. Furthermore, the power semiconductors can be made of silicon (Si) for one of the inverters 10, 10′ and silicon carbide (SiC) for the other, advantageously using SiC-MOSFETs and Si-IGBTs. The power semiconductors for the inverters 10, 10′ can have different surface areas, etc. The one inverter 10′ is then connected to the windings a, b, and c, while the other inverter 10′ is connected to the windings a′, b′, c′. Both inverters 10, 10′ can be controlled independently, with different performances. If one of the inverters 10, 10′ malfunctions, operation can continue using the other inverter 10, 10′. Because of the galvanic separation of the windings a-c and a′-c′, the inverters 10, 10′ do not have to satisfy any other requirements. The switching frequency can be set separately for each inverter 10, 10′.

By using two inverters 10, 10′, which have different power semiconductors, optimal use can be made of the properties of the different semiconductor components.

The control assembly can be used to control a six-phase electric machine 100 in a vehicle that has an electric drive.

A six-phase electric machine 100 for an electric drive in a vehicle, which has the proposed control assembly, and an electric drive with a six-phase electric machine 100, and a vehicle with an electric drive are also obtained.

Inverters 10, 10′ for electric drives in vehicles, in particular passenger automobiles and utility vehicles, as well as busses, are designed for high voltages of 650 V to 1,200 V, or batter voltages of ca. 400 V to 800 V, or even starting at 200 V.

### LIST OF REFERENCE SYMBOLS

100 six-phase electric machine
1-3 cogs
10, 10′ inverters
a-c and a′-c′ windings in 10 or 10′

1. A control assembly for a six-phase electric machine divided into two three-phase windings, comprising: two three-phase inverters, each of which controls one of the three-phase windings,
wherein each inverter (comprises a circuit assembly with power semiconductors of different types, different materials, and/or different surface areas, and
wherein windings of a same phase in the inverter are wound onto a same cog and are galvanically insulated from one another.

2. The control assembly according to claim 1, wherein the inverters are the same or different with regard to their performance and/or efficiency.

3. The control assembly according to claim 1, wherein the windings and their dedicated inverters are optimized to one another with regard to a predefined performance and/or efficiency to be obtained from the inverters
and/or for a predefined operating point of the electric machine .

4. The control assembly according to claim 3, wherein an optimization of the windings is obtained by adjusting a wire geometry, number of windings, type of windings, orientation, and/or an arrangement on the cogs.

5. The control assembly according to claim 4, wherein the windings are arranged on the cogs either successively or concentrically, one above the other.

6. The control assembly according to claim 1, wherein a first one of the inverters contains power semiconductors that form unipolar semiconductor components, and wherein a second one of the inverters contains power semiconductors that form bipolar semiconductor components.

7. The control assembly according to claim 6, wherein the first one of the inverters contains power semiconductors made of a material with wider bandgaps, comprising SiC or GaN, and wherein the second one of the inverters contains power semiconductors made of silicon, and/or
wherein the unipolar semiconductor components are MOSFETs, JFETs, or cascodes, and/or
wherein the bipolar semiconductor components are IGBTs.

8. The control assembly according to claim 1, configured to control a six-phase electric machine in a vehicle with an electric drive.

9. A six-phase electric machine for an electric drive in a vehicle, comprising:
the control assembly according to claim 1.

10. An electric drive for a vehicle, comprising:
the six-phase electric machine according to claim 9.

11. A vehicle comprising;
the electric drive according to claim 10.
